(19) United States
(12) Patent Application Publication
(10) Pub. No.: US 2024/0211614 A1
(43) Pub. Date: Jun. 27, 2024

(54) VERIFICATION SYSTEM, VERIFICATION METHOD, AND VERIFICATION PROGRAM

(71) Applicant: Nomura Research Institute, Ltd., Tokyo (JP)

(72) Inventors: Masashi KAWAGUCHI, Tokyo (JP); Satoshi YOSHIMURA, Tokyo (JP)

(21) Appl. No.: 18/372,984

(22) Filed: Sep. 26, 2023

(30) Foreign Application Priority Data
Dec. 21, 2022 (JP) 2022-204016

(51) Int. Cl. G06F 21/62; G06F 21/10

(52) U.S. Cl. CPC G06F 21/6209; G06F 21/10

(57) ABSTRACT

A verification system includes: a content acquisition unit that acquires, from a user terminal of a user, content data provided to an external information processing system providing an environment in which content can be used; a relationship information acquisition unit that acquires, from the user terminal, relationship information indicating a relationship between the user and the content data under the environment in association with the content data; and a verification unit that verifies that the user is a valid right holder of the content data based on the relationship information.

### BACKGROUND OF THE INVENTION

### 1. Technical Field

The present invention relates to a verification system, a verification method, and a verification program.

### 2. Description of the Related Art

What has been conventionally known is a system that verifies whether or not a service provision request is from a valid right holder during provision of a service.

For example, an ID cooperation authentication system described in JP 2007-299303 A includes a client terminal, a service server, and an authentication proxy server, all of which are connected to a communication network. The service server receives a service request from the client terminal and transmits a single sign-on request to the authentication proxy server. As a result of the single sign-on request received, the authentication proxy server transmits, to the service server, a required ID for the service server and authentication result information describing that authentication has been completed. The service server executes a service based on the authentication result information, and transmits, to the client terminal, results of the service executed.

### SUMMARY OF THE INVENTION

Meanwhile, in recent years, there are a plurality of service servers, and each of the plurality of the service servers independently manages an ID of a user. Therefore, in a case where a system for authenticating a user authenticates the user based on authentication information in other service servers used by the user, it is necessary to include a system that can cooperate with the other service servers. Then, when the system incorporates a large number of users, it is necessary to include a system that can cooperate with a larger number of the other service servers.

As an example of necessity of cooperation based on the authentication information, it is necessary to prevent a situation in which a person other than a right holder of a digital work can issue an NFT by using the same work and obtain a profit on a platform capable of issuing the NFT.

Further, as another example, it is necessary to prevent a situation in which a person other than the right holder can perform learning and inference by using the digital work and obtain a profit on a platform capable of creating Al (a learned model) using the digital work as an input value.

However, in the ID cooperation authentication system described in JP 2007-299303 A, it is necessary to perform an authentication process for each service server, and the process becomes complicated in a case where a combination of the user and the service server increases.

Therefore, an object of the present invention is to provide a verification system, a verification method, and a verification program, all of which can easily verify that a user is a valid user.

A verification system according to one aspect of the present invention includes: a content acquisition unit that acquires, from a user terminal of a user, content data provided to an external information processing system providing an environment in which content can be used; a relationship information acquisition unit that acquires, from the user terminal, relationship information indicating a relationship between the user and the content data under the environment in association with the content data; and a verification unit that verifies that the user is a valid right holder of the content data based on the relationship information.

A verification method according to one aspect of the present invention includes: by a computer, acquiring, from a user terminal of a user, content data provided to an external information processing system providing an environment in which content can be used; acquiring, from the user terminal, relationship information indicating a relationship between the user and the content data under the environment in association with the content data; and verifying that the user is a valid right holder of the content data based on the relationship information.

A verification program according to one aspect of the present invention causes a computer to implement a content acquisition unit that acquires, from a user terminal of a user, content data provided to an external information processing system providing an environment in which content can be used; a relationship information acquisition unit that acquires, from the user terminal, relationship information indicating a relationship between the user and the content data under the environment in association with the content data; and a verification unit that verifies that the user is a valid right holder of the content data based on the relationship information.

Note that, in the present invention, the “unit” does not simply mean a physical unit, and comprehends a case where functions of the “unit” are implemented by software. Further, functions of one “unit” or device may be implemented by two or more physical units, devices, or pieces of software, and functions of two or more “units” or devices may be implemented by one physical unit, one device, or one piece of software.

According to the present invention, it is possible to provide a verification system, a verification method, and a verification program, all of which can easily verify that a user is a valid user.

### BRIEF DESCRIPTION OF THE DRAWINGS

FIG. 1 is a diagram illustrating an outline of a process in a verification system according to one embodiment of the present invention;

FIG. 2 is a diagram illustrating a configuration of the verification system according to one embodiment of the present invention;

FIG. 3 is a diagram illustrating an example of content registration information to be stored in a storage unit;

FIG. 4 is a diagram illustrating an example of relationship information to be stored in the storage unit;

FIG. 5 is a diagram illustrating an example of user information to be stored in the storage unit;

FIG. 6 is a diagram illustrating an example of verification result information to be stored in the storage unit; and

FIG. 7 is a flowchart illustrating an example of a process in the verification system.

### DETAILED DESCRIPTION

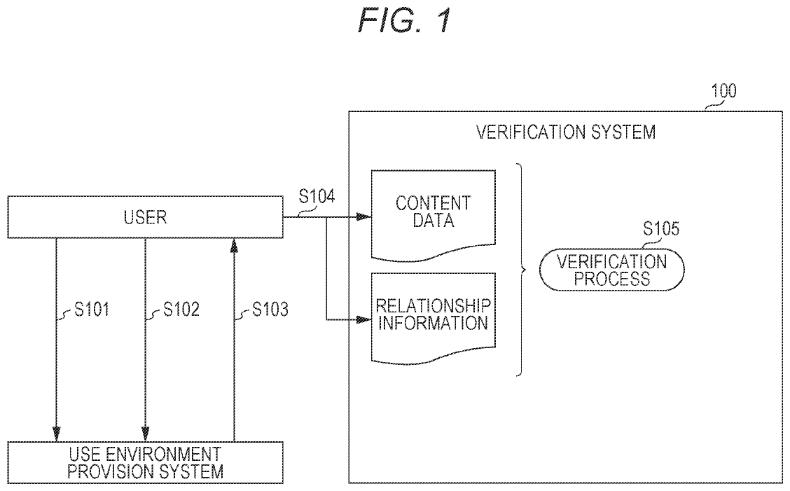

Preferred embodiments of the present invention will be described with reference to accompanying drawings. FIG. 1 is a diagram illustrating an outline of a process in a verification system 100 according to one embodiment of the present invention.

The verification system 100 is an information processing system that is implemented by a verification program, and acquires, from a user, content data and relationship information and verifies that the user is a valid right holder of the content data based on the relationship information.

First, the user provides content to a use environment provision system that provides an environment in which the content can be used (S101). The user requests the use environment provision system to generate the relationship information (S102). The use environment provision system generates the relationship information and provides the relationship information to the user (S103). Note that, the user may generate the relationship information by using a user terminal.

Next, the user provides the content data and the relationship information to the verification system 100 (S104). The verification system 100 performs a verification process of verifying that the user is a valid right holder of the content data based on the relationship information (S105).

The user may issue a token (for example, a non-fungible token (NFT)) based on the content data, or acquire a learning result obtained by adding the content data to learning data by using a predetermined information processing system (for example, a token issuing system and a learning system). At that time, in a case where the user who provides the content data is not the valid right holder of the content data, the predetermined information processing system may be held responsible for illegal use of the content data from the valid right holder. Therefore, the verification system 100 verifies that the user who provides the content data is the valid right holder of the content data.

In this regard, it is conceivable to use an account information verification system verifying that the user is the valid right holder of the content data based on account information of the user in the use environment provision system. However, since such account information verification system is required to have a function of verifying and processing the account information for each use environment provision system used by the user, it is assumed that a large amount of work will occur in design and maintenance of the account information verification system in a case where a large number of the use environment provision systems used by the user are assumed.

Therefore, the verification system 100 according to one embodiment of the present invention verifies that the user is a valid right holder of the content data based on relationship information indicating a relationship between the user and the content data. In other words, the verification system 100 uses the relationship information to achieve a decentralized identification (DID) in order to verify a connection between the user and the content.

Note that, the verification system 100 may be an information processing system to be incorporated in the information processing system (for example, the token issuing system and the learning system) to be used in a case where the user issues the token (for example, the non-fungible token (NFT)) based on the content data or acquires the learning result obtained by adding the content data to the learning data.

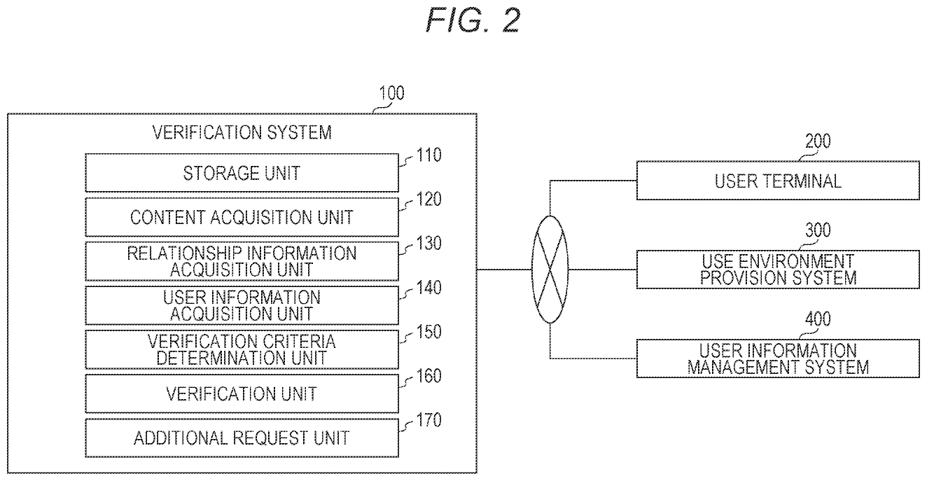

FIG. 2 is a diagram illustrating a configuration of the verification system 100 according to one embodiment of the present invention. The verification system 100 is communicably connected to a user terminal 200, a use environment provision system 300, and a user information management system 400 via a network such as the Internet. Details of the verification system 100 will be described later.

The user terminal 200 is a computer to be used by the user, and is, for example, a smartphone, a tablet terminal, or a personal computer.

The user provides the content data and the relationship information to the verification system 100 by using the user terminal 200.

Further, the user can provide the content data to the use environment provision system 300 by using the user terminal 200. Further, the user can request the use the environment provision system 300 to provide the relationship information by using the user terminal 200, and acquire the relationship information from the use environment provision system 300.

The use environment provision system 300 is an external information processing system that provides the environment in which the content can be used. The use environment provision system 300 stores, for example, content data provided (uploaded) by the user in a file storage that can be used by the user providing the content data or users other than the user providing the content data. In other words, the use environment provision system 300 may be an information processing system that provides a platform on which the content data provided by the user can be used by the users.

The user information management system 400 is an information processing system that manages user information related to the user and provides the user information to the verification system 100.

The user information management system 400 may be, for example, an information processing system that manages payment history information related to a payment history of the user. In a case where the user information management system 400 is an information processing system that manages the payment history information, the user information management system 400 may be, for example, an information processing system of a business operator (for example, a credit card issuing company or a fund transfer company) that manages a payment medium (for example, a credit card or electronic money) to be used by the user for payment.

Note that, in FIG. 2, one user terminal 200, one use environment provision system 300, and one user information management system 400 are illustrated, but a plurality of the user terminals 200, the use environment provision systems 300, and the user information management systems 400 may be used.

Next, the details of the verification system 100 will be described. The verification system 100 includes a storage unit 110, a content acquisition unit 120, a relationship information acquisition unit 130, a user information acquisition unit 140, a verification criteria determination unit 150, a verification unit 160, and an additional request unit 170. Each unit illustrated in FIG. 2 can be implemented, for example, by using a storage area or causing a processor to execute a program stored in the storage area.

The storage unit 110 stores information to be processed in the verification system 100. The storage unit 110 can store, for example, the content registration information, the relationship information, the user information, and the verification result information to be described later.

The content acquisition unit 120 acquires, from the user terminal 200, content data provided to the external information processing system (for example, the use environment provision system 300) that provides the environment in which the content can be used, and stores the content registration information in the storage unit 110.

At this time, the content acquisition unit 120 may receive registration of the content data in response to acquisition of the content data, and generate content registration information related to the registration of the content data. Then, the content acquisition unit 120 stores the content registration information in the storage unit 110.

The content data to be acquired by the content acquisition unit 120 may be data related to any content. In other words, the content data may be, for example, data related to a digital literary work such as an image or a moving image, music, software, model data, or an access token (a virtual key).

The image may be, for example, a photograph or an illustration. The image may be an electronically created image, and may be a developed photograph or a handwritten or printed illustration digitized by a predetermined method (for example, scanning).

The moving image may be, for example, a video image, an animation image, or a computer graphics image. The music may be, for example, sound data in which a musical composition, a conversation, a sound, or the like are recorded.

The software may be, for example, an application for content creation or a program that performs a series of processes for other purposes. The model data may be, for example, model data or a mathematical model specialized for a certain person or problem, or a learned artificial intelligence model having a specific character or tendency.

The content data may be any data to be distributed and provided in a subscription format.

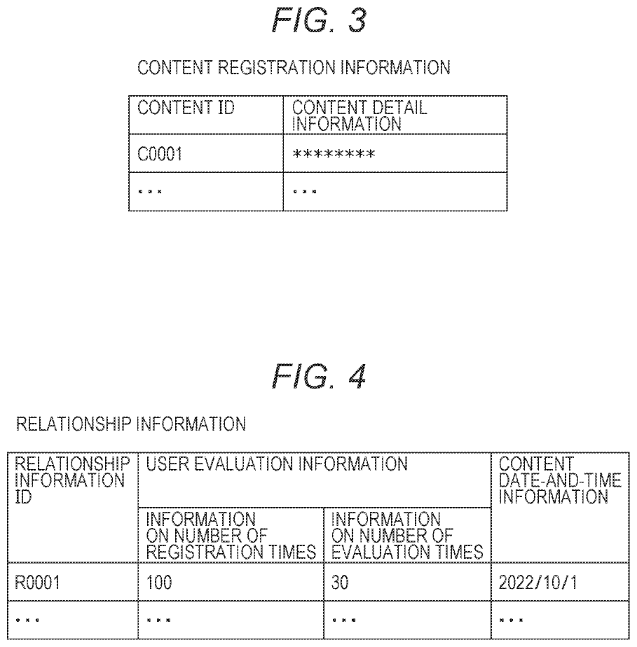

FIG. 3 is a diagram illustrating an example of content registration information to be stored in a storage unit 110. The content registration information to be stored in the storage unit 110 includes, for example, a content ID and content detail information.

The content ID is content data identification information for identifying the content data.

The content detail information is information related to details of the content data (that is, a data entity). The details of the content data may correspond to, for example, a base 64-encoded character string.

Note that, the content registration information may include storage location information (for example, a uniform resource locator (URL)) indicating a storage location where the content data is stored, instead of the content detail information.

The relationship information acquisition unit 130 acquires, from the user terminal 200, the relationship information indicating the relationship between the user and the content data in an environment (hereinafter, referred to as a “content use environment”) to be provided by the use environment provision system 300 in association with the content data, and stores the relationship information in the storage unit 110.

First, the user requests the use environment provision system 300 to provide the relationship information through the user terminal 200. The use environment provision system 300 generates the relationship information in response to a provision request from the user, and provides the relationship information to the user terminal 200. Then, the user terminal 200 provides the relationship information acquired from the use environment provision system 300 to the verification system 100. The relationship information acquisition unit 130 acquires the relationship information from the user terminal 200.

Note that, in a case where the content data is provided to the plurality of the use environment provision systems 300, the user may request the plurality of the use environment provision systems 300 to provide a plurality of pieces of the relationship information through the user terminal 200, and acquire the plurality of pieces of the relationship information from the plurality of the use environment provision systems 300. Then, the relationship information acquisition unit 130 may acquire the plurality of pieces of the relationship information.

Here, the relationship information is information indicating the relationship between the user and the content data, and is information to be used when the user is verified as the valid right holder of the content data.

The relationship information may include, for example, user attribute information related to attributes of the user in the content use environment. The user attribute information may include, for example, identification information of the user registered in the use environment provision system 300, or information related to a gender, an address, or the like.

Further, the user attribute information may include user evaluation information related to evaluation on the user from users other than the user in the content use environment.

The user evaluation information may include, for example, information related to the number of times (for example, favorite registration, channel registration, or following) registered by the users (that is, for example, the number of registrants and the number of followers) in the content use environment. Further, the user evaluation information may include information related to the number of times of evaluation (for example, “good”) on the user or the content provided by the user in the content use environment.

Note that, the relationship information may be information encrypted by a predetermined encryption process, and may be information to which signature information or digital watermark information of the user or the use environment provision system 300 is added through a predetermined method. Accordingly, even in a case where the relationship information is leaked, only the valid user can use the relationship information, and the verification system 100 can prevent a malicious user from using illegal content.

The user provides the content data and the relationship information associated with each other to the verification system 100. At this time, the user may provide the content data and the relationship information to the verification system 100 through a series of operations. Further, the user may provide the content data to the verification system 100 at first, and then provide the relationship information in association with information (for example, the content ID) indicating that the relationship information corresponds to the content data provided. Note that, order of provision of the content data and the relationship information by the user does not matter.

Note that, the relationship information acquisition unit 130 may acquire, from the user terminal 200, the relationship information generated by the use environment provision system 300, and may acquire the relationship information generated in the user terminal 200.

In a case where the relationship information is generated in the user terminal 200, the relationship information may be, for example, relationship information that can be verified as valid relationship information by using a blockchain technique. Accordingly, it is possible to avoid an illegal generation of the relationship information by the user.

FIG. 4 is a diagram illustrating an example of the relationship information to be stored in the storage unit 110. The relationship information to be stored in the storage unit 110 includes, for example, a relationship information ID, user evaluation information, and content date-and-time information.

The relationship information ID is information for identifying the relationship information to be stored in the storage unit 110.

The user evaluation information includes, for example, information on number of registration times and information on number of evaluation times.

The information on number of registration times is, for example, the information related to the number of times (for example, the favorite registration, the channel registration, or the following) registered by the users (that is, for example, the number of the registrants and the number of the followers).

The information on number of evaluation times is, for example, the information related to the number of times of the evaluation (for example, “good”) on the user or the content provided by the user.

The content date-and-time information is, for example, information related to a date and time when corresponding content data is provided to the use environment provision system 300.

Further, the relationship information may further include use frequency information and connection number information.

The use frequency information is, for example, information indicating a use frequency of the user in the use environment provision system 300.

The connection number information is, for example, information related to the number of other users (for example, “mates” and “friends”) connected to the user in the use environment provision system 300.

The user information acquisition unit 140 acquires the user information from a predetermined information processing system (for example, the user information management system 400), and stores the user information in the storage unit 110.

Here, the user information is information related to the user, for example, information indicating credit of the user. The user information may include, for example, the payment history information related to the payment history of the user, and may include other information.

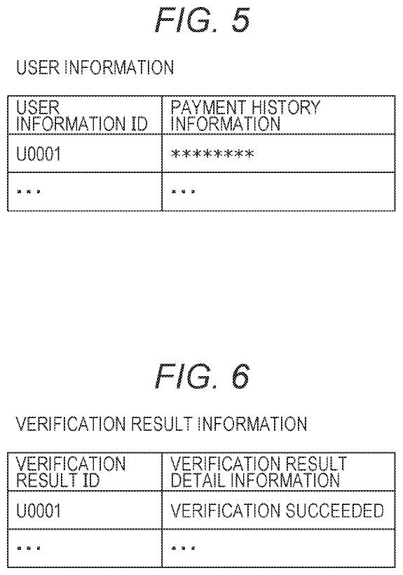

FIG. 5 is a diagram illustrating an example of the user information to be stored in the storage unit 110. The user information to be stored in the storage unit 110 includes, for example, a user information ID and the payment history information. The user information ID is information for identifying the user information to be stored in the storage unit 110.

The verification criteria determination unit 150 determines verification criteria in the verification unit 160 to be described later based on the user information to be acquired from the predetermined information processing system (for example, the user information management system 400).

The verification criteria determination unit 150 evaluates the credit of the user based on the user information. Then, the verification criteria determination unit 150 determines the verification criteria in the verification unit 160 according to the credit of the user to be evaluated.

The verification criteria determination unit 150 may evaluate the credit of the user to be low based on the payment history information included in the user information, for example, in a case where the user has a payment delay history.

The verification unit 160 verifies that the user is the valid right holder of the content data based on the relationship information, and stores the verification result information indicating a verification result in the storage unit 110.

When verifying that the user is the valid right holder of the content data, the verification unit 160 may, for example, verify that the user is an author (for example, a creator or a photographer) of the content data.

The verification unit 160 may verify that the user is the valid right holder of the content data based on the information on number of registration times included in the relationship information, for example, in a case where the number of registration times indicated by the information on number of registration times is large. Further, the verification unit 160 may verify that the user is the valid right holder of the content data based on the number of evaluation times indicated by the information on number of evaluation times included in the relationship information, for example, in a case where the number of the evaluation times is large.

In the case where the number of the registration times indicated by the information on number of registration times is large or a case where the number of the evaluation times indicated by the information on number of evaluation times is large, it may be indicated that the user has obtained a certain credit in the content use environment. Therefore, the verification unit 160 evaluates that the user is the valid right holder of the content data in the case where the number of the registration times indicated by the information on number of registration times is large or the case where the number of the evaluation times indicated by the information on number of evaluation times is large. Accordingly, it is possible to prevent the malicious user from using the illegal content.

The verification unit 160 may verify that the user is the valid right holder of the content data, for example, in a case where the content has been registered for long enough past a verification date and time based on the content date-and-time information included in the relationship information, and may verify that the user is not the valid right holder of the content data in a case where the content has been registered immediately before the verification date and time.

In a case where the malicious user attempts to illegally use the content, the malicious user may use the verification system 100 immediately after providing, to the use environment provision system 300, the content data illegally acquired. Therefore, the verification unit 160 evaluates that the user is the valid right holder of the content data in the case where the content has been registered for long enough past the verification date and time, and evaluates that the user is not the valid right holder of the content data in the case where the content has been registered immediately before the verification date and time. Accordingly, it is possible to prevent the malicious user from using the illegal content.

The verification unit 160 may verify that the user is the valid right holder of the content data based on the use frequency information included in the relationship information, for example, in a case where the use frequency indicated by the use frequency information is high.

A user who uses the use environment provision system 300 more frequently may be evaluated as a user who has a high credit. Therefore, the verification unit 160 verifies that the user is the valid right holder of the content data in the case where the use frequency indicated by the use frequency information is high. Accordingly, it is possible to prevent the malicious user from using the illegal content.

The verification unit 160 may verify that the user is the valid right holder of the content data based on the connection number information included in the relationship information, for example, in a case where the number of connections indicated by the connection number information is large.

A user who has a larger number of connections in the use environment provision system 300 may be evaluated as the user who has the high credit. Therefore, in the case where the number of the connections indicated by the connection number information is large, the verification unit 160 verifies that the user is the valid right holder of the content data. Accordingly, it is possible to prevent the malicious user from using the illegal content.

Further, the verification unit 160 may verify that the user is the valid right holder of the content data further based on criteria determined by the verification criteria determination unit 150. Note that, the connection number information may be a method for simply counting the number of connections with a target user, such as the number of followed accounts and the number of times of good evaluation, or may be a method for performing counting in consideration of the connection number information of each user connected with the target user. Specifically, the connection number information is a method for counting the number of the connections to be larger in a case where a user having a large number of the connections is connected to the target user than the number of the connections in a case where a user having a small number of the connections is connected to the target user.

Further, the verification unit 160 may, for example, recognize relationship information having an old generation date and time as correct relationship information and perform the verification in a case where the verification is performed based on a plurality of pieces of relationship information that contradict each other.

The right holder who initially generates the content data is considered to be the right holder (for example, the author) of the content data. Therefore, the verification unit 160 can more accurately verify that the user is the valid right holder (for example, the author) of the content data by recognizing older relationship information as the correct relationship information.

FIG. 6 is a diagram illustrating an example of the verification result information to be stored in the storage unit 110. The verification result information to be stored in the storage unit 110 includes, for example, a verification result ID and verification result detail information.

The verification result ID is information for identifying the verification result information to be stored in the storage unit 110.

The verification result detail information is information indicating details of a verification result. The verification result detail information may include, for example, “verification succeeded” indicating that the user has been verified as the valid right holder of the content data, and “verification failed” indicating that the user has not been verified as the valid right holder of the content data. Note that, a format of the verification result detail information is not limited thereto.

The additional request unit 170 requests, from the user terminal 200, the relationship information necessary for the verification by the verification unit 160 based on the verification result by the verification unit 160.

Even in a case of the “verification failed” in the verification unit 160, the verification unit 160 verifies that the user is the valid right holder of the content data further based on the relationship information to be additionally provided from the user terminal 200, and may result in the “verification succeeded”. Therefore, the additional request unit 170 can extract the relationship information additionally necessary for verifying that the user is the valid right holder of the content data based on the verification result by the verification unit 160, and request the user terminal 200 to provide the relationship information. Here, the user actively extracts additionally necessary relationship information, but the user terminal 200 may be configured to periodically extract the relationship information or the additionally necessary relationship information, and provide the relationship information or the additionally necessary relationship information to the verification system 100.

At this time, the verification system 100 may retain information list indicating a list of types of pieces of relationship information that can be provided from the user terminal 200, and the additional request unit 170 may extract relationship information that is not provided from the user terminal 200 among the pieces of the relationship information described in the information list as the additionally necessary relationship information with reference to the information list.

Note that, the information list may be information set in advance by an administrator of the verification system 100, and may be information to be generated by aggregating the relationship information provided from the user terminal 200.

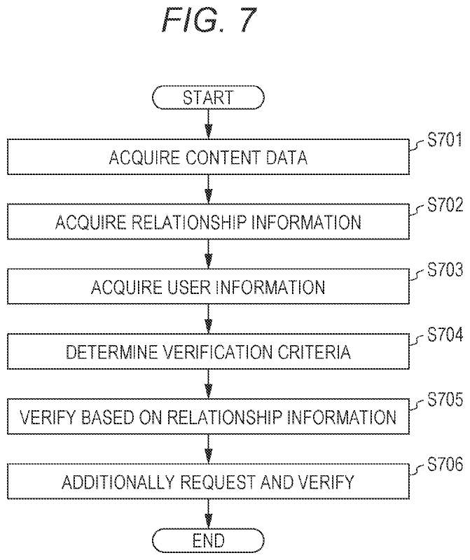

FIG. 7 is a flowchart illustrating an example of a process in the verification system 100.

First, the content acquisition unit 120 acquires the content data from the user terminal 200 (S701). The relationship information acquisition unit 130 acquires the relationship information from the user terminal 200 in association with the content data (S702).

The user information acquisition unit 140 acquires the user information from the predetermined information processing system (for example, the user information management system 400) (S703). The verification criteria determination unit 150 determines the verification criteria based on the user information (5704).

The verification unit 160 verifies that the user is the valid right holder of the content data based on the relationship information (S705). At this time, the verification unit 160 may perform the verification further based on the verification criteria determined by the verification criteria determination unit 150. Then, the additional request unit 170 requests, from the user terminal 200, the relationship information necessary for the verification by the verification unit 160 based on the verification result by the verification unit 160, and the verification unit 160 performs the verification further based on the relationship information additionally acquired (S706).

Note that, a user information acquisition process by the user information acquisition unit 140 and a verification criteria determination process by the verification criteria determination unit 150 may not be performed. In this case, the verification unit 160 may perform the verification process based on the relationship information.

Further, an additional request process by the additional request unit 170 may not be performed. In this case, the verification unit 160 may notify the administrator or the user of the verification system that the verification cannot be performed in a case where the verification unit cannot verify that the user is the valid right holder of the content data.

One embodiment of the present invention has been described above. The verification system 100 can acquire the content data and the relationship information from the user terminal 200, and verify that the user is the valid right holder of the content data based on the relationship information. Accordingly, the verification system 100 can simply verify that the user who provides the content data is the valid user.

Further, the verification system 100 can verify that the user is the valid right holder of the content data based on the relationship information including the user attribute information. Further, the verification system 100 can verify that the user is the valid right holder of the content data based on the relationship information including the user evaluation information. Accordingly, the verification system 100 can prevent the malicious user from using the illegal content.

Further, the verification system 100 can determine the verification criteria based on the user information to be acquired from the predetermined information processing system, and verify that the user is the valid right holder of the content data further based on the verification criteria determined. Accordingly, it is possible to verify that the user is the valid right holder of the content data based on appropriate criteria according to the user.

Further, the verification system 100 can request, from the user terminal 200, the relationship information necessary for the verification according to the verification result. Accordingly, even in a case where the user has not been verified as the valid right holder of the content data, the user can further provide necessary relationship information to request the verification that the user is the valid right holder of the content data.

Note that, the present embodiment is for facilitating understanding of the present invention and is not intended to limit the present invention. The present invention can be modified and improved without departing from the gist of the invention, and equivalents thereof are also included in the present invention.

What is claimed is:

1. A verification system comprising:
a content acquisition unit that acquires, from a user terminal of a user, content data provided to an external information processing system providing an environment in which content can be used;
a relationship information acquisition unit that acquires, from the user terminal, relationship information indicating a relationship between the user and the content data under the environment in association with the content data; and
a verification unit that verifies that the user is a valid right holder of the content data based on the relationship information.

2. The verification system according to claim 1, wherein the relationship information includes user attribute information related to attributes of the user in the environment.

3. The verification system according to claim 2, wherein the user attribute information includes user evaluation information related to evaluation on the user from users other than the user in the environment.

4. The verification system according to any one of claim 1, further comprising a verification criteria determination unit that determines verification criteria in the verification unit based on user information related to the user to be acquired from a predetermined information processing system,
wherein the verification unit verifies that the user is the valid right holder of the content data further based on the criteria determined.

5. The verification system according to any one of claim 1, further comprising an additional request unit that requests, from the user terminal, the relationship information necessary for verification by the verification unit according to a verification result by the verification unit.

6. A verification method comprising:
by a computer,
acquiring, from a user terminal of a user, content data provided to an external information processing system providing an environment in which content can be used;
acquiring, from the user terminal, relationship information indicating a relationship between the user and the content data under the environment in association with the content data; and
verifying that the user is a valid right holder of the content data based on the relationship information.
